(19) United States
(12) Patent Application Publication
(10) Pub. No.: US 2006/0023609 A1
(43) Pub. Date: Feb. 2, 2006

(54) Optical pickup apparatus, optical recording and reproducing apparatus and optical recording and reproducing method

(75) Inventors: Kenji Yamamoto, Kanagawa (JP); Katsutoshi Sato, Tokyo (JP); Noriaki Nishi, Kanagawa (JP); Midori Kanaya, Tokyo (JP); Shinya Makita, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/182,883

(22) Filed: Jul. 18, 2005

(30) Foreign Application Priority Data
Aug. 2, 2004 (JP) 2004-225833

(51) Int. Cl. G11B 7/135; G11B 7/00

(52) U.S. Cl. 369/112.01; 369/116

(57) ABSTRACT

An optical pickup apparatus includes a semiconductor laser for emitting laser light with a wavelength of at least from 400 nm to 415 nm and of which plane parallel to an active layer is located substantially in parallel to the recording surface of an optical recording medium and a reflection surface for reflecting laser light emitted from the semiconductor laser in the direction substantially perpendicular to the recording surface of the optical recording medium, the laser light being irradiated on the optical recording medium through an objective lens to record and/or reproduce the optical recording medium, wherein an angle θ formed between the direction of rays of light introduced into the reflection surface from the semiconductor laser and the direction in which recording tracks of the optical recording medium are extended is selected so as to satisfy:
45°≦θ<90° Then, in an optical pickup apparatus and an optical recording and reproducing apparatus that can suitably applied to an optical recording medium including an optical recording medium having a BD (Blu-ray Disc) type arrangement, it is possible to maintain satisfactory recording and reproducing characteristics by irradiating light with a beam spot of an optimum profile on recording tracks.

### CROSS REFERENCES TO RELATED APPLICATIONS

The present invention contains subject matter related to Japanese Patent Application JP 2004-225833 filed in the Japanese Patent Office on Aug. 2, 2004, the entire contents of which being incorporated hereby by reference.

### BACKGROUND OF THE INVENTION

1. Field of the Invention

The present invention relates to an optical pickup apparatus, an optical recording and reproducing apparatus and an optical recording and reproducing method suitable for use in recording and/or reproducing a high recording density optical recording medium with very narrow track pitches.

2. Description of the Related Art

In recent years, in optical recording mediums, various types of optical recording mediums with different recording densities have been developed. In disc-like optical recording mediums, there are enumerated a CD (Compact Disc) in which laser light having a wavelength near 780 nm is available, a DVD (Digital Versatile Disc) in which laser light having a wavelength near 660 nm is available, a BD (Blu-ray Disc) in which laser light having a wavelength near 405 nm is available, a HD-DVD (High Definition DVD) in which laser light having a wavelength near 405 nm is available and so forth.

These optical recording mediums have different structures. In order to increase recording densities, as compared with the optical recording medium conforming to the CD standards having a track pitch of 1.6 μm, a track pitch of the optical recording medium conforming to the DVD standards is decreased to 0.74 μm and a track pitch of the optical recording medium conforming to the BD standards is decreased to approximately 0.3 to 0.35 μm.

It is desirable that recording tracks with narrow track pitches should be irradiated with a beam spot of an optimum shape of light from a light source efficiently. These are conditions by which recording and reproducing characteristics can be maintained satisfactory. If the shape of the beam spot is not optimized so as to match with conditions such as the recording track width, the recording and reproducing characteristics will be degraded.

As a method of shaping recording and/or reproducing light of an optical recording medium to provide light with a proper beam shape on the optical path, there is provided a method of adjusting the direction of a beam intensity distribution of a far-field pattern of light emitted from a semiconductor laser by rotation of the semiconductor laser around the optical axis of laser light or a method of optimizing a shape of a beam spot by using a beam shape shaping element such as an anamorphic prism (see United State Patent Application Publication :US2002/0114229A1, for example).

According to the method described in the above-described US2002/0114229A1, when a so-called spot size method for obtaining a focusing error signal by detecting the change of a spot size on the detecting element is used, if a spot is formed on the detecting element in such a manner that the spot size in the direction corresponding to the radius direction of a disc-like optical recording medium may be minimized, then it becomes possible to stably detect a signal.

However, with respect to the method for adjusting the direction of the beam intensity distribution of the far-field pattern of light emitted from the above-mentioned semiconductor laser by the rotation of the semiconductor laser, when the semiconductor laser is rotated without freedom, since a semiconductor laser housed in a can package, which was already put into practice as the application to thin optical pickup devices, for example, is decreased in thickness in its direction perpendicular to the active layer, it is difficult to rotate the semiconductor laser and hence it is difficult to adjust the spot size on the disc-like optical recording medium.

Furthermore, if the relatively expensive beam profile converter such as the anamorphic prism is used, then a cost is increased unavoidably and problems arise, in which it is difficult to make the apparatus become small in size and to reduce the thickness of the apparatus.

### SUMMARY OF THE INVENTION

In view of the aforesaid aspect, the present invention intends to provide an optical pickup apparatus and an optical recording and reproducing apparatus suitably applicable to an optical recording medium including an optical recording medium which is recorded and/or reproduced by using light with a wavelength of at least 400 nm to 415 nm and in which a beam spot of an optimum profile can be irradiated on recording tracks of the optical recording medium without using a beam profile converter.

According to an aspect of the present invention, there is provided an optical pickup apparatus which is composed of a semiconductor laser for emitting laser light with a wavelength of at least from 400 nm to 415 nm and of which plane parallel to an active layer is located substantially in parallel to the recording surface of an optical recording medium and a reflection surface for reflecting laser light emitted from the semiconductor laser in the direction substantially perpendicular to the recording surface of the optical recording medium, the laser light being irradiated on the optical recording medium through an objective lens to record and/or reproduce the optical recording medium, wherein an angle θ formed between the direction of rays of light introduced into the reflection surface from the semiconductor laser and the direction in which recording tracks of the optical recording medium are extended is selected so as to satisfy:
45°≦θ<90°

Also, according to the present invention, in the above-mentioned optical pickup apparatus, the above-described angle θ is selected so as to satisfy:
45°≦θ≦55°

Further, according to the present invention, in the above-mentioned respective optical pickup apparatus, when θ⊥ assumes a spread angle of a far-field pattern, perpendicular to the active layer, of laser light emitted from the semiconductor laser and θ// assumes a spread angle of a far-field pattern parallel to the active layer, the following equation is given as:
2≦θ⊥/θ//≦4

According to other aspect of the present invention, there is provided an optical recording and reproducing apparatus including an optical pickup apparatus which is composed of a semiconductor laser for emitting laser light with a wavelength of at least from 400 nm to 415 nm and of which plane parallel to an active layer is located substantially in parallel to the recording surface of an optical recording medium and a reflection surface for reflecting laser light emitted from the semiconductor laser in the direction substantially perpendicular to the recording surface of the optical recording medium, the laser light being irradiated on the optical recording medium through an objective lens to record and/or reproduce the optical recording medium, wherein an angle θ formed between the direction of rays of light introduced into the reflection surface from the semiconductor laser and the direction in which recording tracks of the optical recording medium are extended is selected so as to satisfy:
45°≦θ<90°

Further, according to the present invention, in the above-mentioned optical recording and reproducing apparatus, the above-described angle θ is selected so as to satisfy:
45°≦θ≦55°

In accordance with a further aspect of the present invention, there is provided an optical recording and reproducing method, in which a semiconductor laser is provided as a light source, the direction parallel to an active layer of the semiconductor laser is located in substantially parallel to the recording surface of an optical recording medium, laser light emitted from the semiconductor laser is reflected by a reflection surface in the direction substantially perpendicular to the recording surface of the optical recording medium and light having a wavelength of at least 400 nm to 415 nm is irradiated on the optical recording medium through an objective lens to record and/or reproduce the optical recording medium, wherein an angle θ formed between the direction of rays of light introduced into the reflection surface from the semiconductor laser and the direction in which recording tracks of the optical recording medium are extended is selected so as to satisfy:
45°≦θ<90°

Furthermore, according to the present invention, in the above-mentioned optical recording and reproducing method, the above-described angle θ is selected so as to satisfy:
45°≦θ≦55°

According to the above-mentioned optical pickup apparatus, optical recording and reproducing apparatus and optical recording and reproducing method of the present invention, when laser light is irradiated on the optical recording medium conforming to the so-called BD standards which may be recorded and/or reproduced with irradiation of laser light having a wavelength of from 400 nm to 415 nm, if the semiconductor laser is rotated without freedom or when the beam profile converter is not used, the profile of the beam spot formed on the recording track of the optical recording medium may be provided in such a manner that the diameter of the beam spot of the so-called tangential direction extending along the recording track may not be decreased but the diameter of the beam spot may be decreased in the direction inclined the inclination angle greater than 45° from this tangential direction.

According to this profile of the beam spot, crosstalk and cross write can be suppressed in the optical recording medium conforming to the above-mentioned BD standards and the optical recording medium can be recorded and/or reproduced with satisfactory recording and reproducing characteristics.

Further, when the angle θ inclined from the tangential direction is selected in a range of from 45° to 55°, in the optical pickup apparatus and the optical recording and reproducing apparatus which are compatible with not only the optical recording medium that conforms to the BD standards but also the optical recording mediums that conform to other DVD standards and CD standards, the respective optical recording mediums can be recorded and/or reproduced with satisfactory recording and reproducing characteristics.

As described above, according to the present invention, there are provided the optical pickup apparatus, the optical recording and reproducing apparatus and the optical recording and reproducing method in which when the light source includes the semiconductor and the direction parallel to the active layer is located in substantially parallel to the recording surface of the optical recording medium, light beam emitted from the semiconductor laser is reflected by the reflection surface in the direction substantially perpendicular to the recording surface of the optical recording medium and light having the wavelength of at least 400 nm to 415 nm is irradiated on the optical recording medium through the objective lens to record and/or reproduce the optical recording medium. When the angle θ formed between the direction of light beam incident on the reflection surface and the direction in which the recording tracks of the optical recording medium are extended is selected in a range of from 45°≦θ<90°, it is possible to obtain satisfactory recording and reproducing characteristics from the optical recording medium which may be recorded and/or reproduced with irradiation of the light having the wavelength of from 400 nm to 415 nm.

Also, when the above-described angle θ is further selected in a range of from 45°≦θ≦55°, it is possible to obtain satisfactory recording and reproducing characteristics from optical recording mediums which may be recorded and/or reproduced with irradiation of light having other wavelength regions.

Furthermore, in the above-mentioned optical pickup apparatus, when the spread angle of the far-field pattern perpendicular to the active layer of light emitted from the semiconductor layer is assumed to be θ⊥ and the spread angle of the far-field pattern parallel to the active layer is assumed to be θ//, 2 ≦θ⊥/θ//≦4 is satisfied and hence the corresponding direction can be selected in the above-mentioned direction so that it is possible to obtain satisfactory recording and reproducing characteristics.

### BRIEF DESCRIPTION OF THE DRAWINGS

FIG. 1 is a diagram showing a schematic arrangement of an optical recording and reproducing apparatus according to an embodiment of the present invention;

FIG. 2 is a diagram showing a schematic arrangement of an optical pickup apparatus according to an embodiment of the present invention;

FIG. 3 is a schematic diagram showing a shape of a beam spot focused on recording tracks on an optical recording medium; and

FIG. 4 is a diagram showing a schematic arrangement of an optical pickup apparatus according to another embodiment of the present invention.

### DESCRIPTION OF THE PREFERRED EMBODIMENTS

Embodiments of the present invention will described hereinafter but it is needless to say that the present invention may not be limited to those embodiments which will follow.

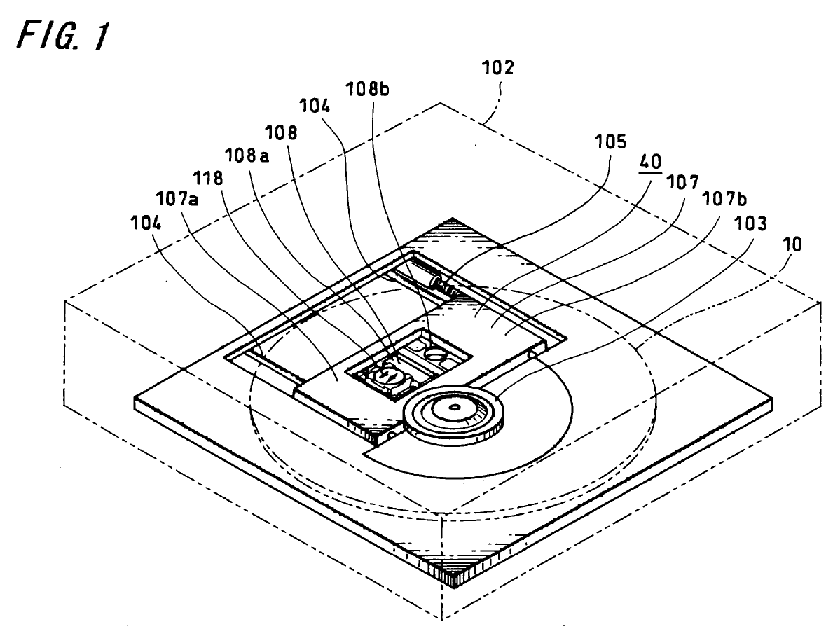

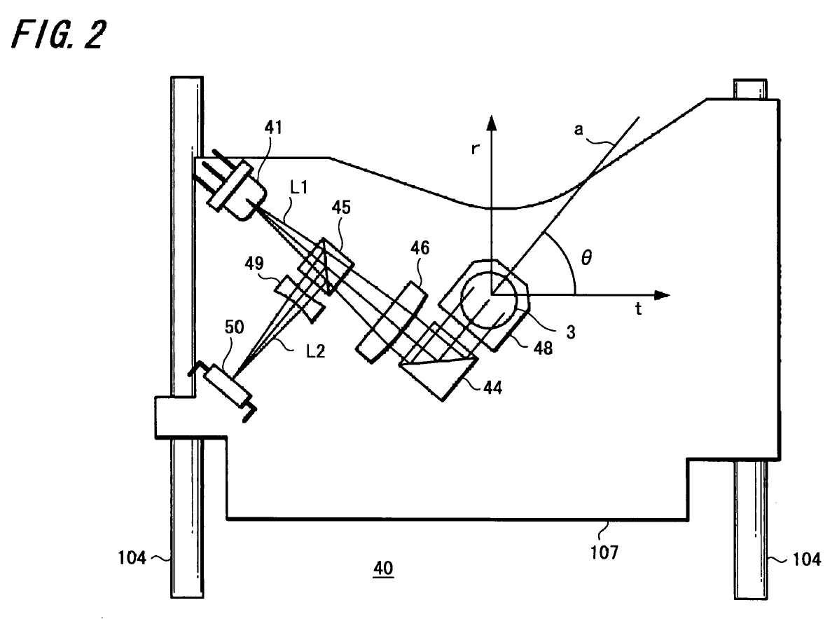

First, examples of an optical recording and reproducing apparatus and an optical pickup apparatus will be described with reference to schematic arrangement diagrams of FIGS. 1 and 2.

As shown in FIG. 1, this optical recording and reproducing apparatus 100 includes an outer casing 102 in which predetermined members and respective mechanisms are located. This outer casing 102 has an insertion slot formed thereon and into and from which a disc-like optical recording medium 10 is inserted and ejected, although not shown.

A spindle motor (not shown) to move the optical recording medium 10 is attached to a chassis (not shown) located within the outer casing 102, and a disc table 103, for example, is fixed to a motor shaft of the spindle motor.

Parallel guide shafts 104 and 104 are attached to the chassis (not shown) and a lead screw 105 which can be rotated by a feed motor (not shown) is supported to the chassis.

This optical recording and reproducing apparatus 100 includes an optical pickup apparatus 40. This optical pickup apparatus 40 includes a moving base 107, predetermined optical assemblies provided on this moving base 107 and an objective lens drive apparatus 108 located on the moving base 107. Bearing portions 107a and 107b provided at respective end portions of the moving base 107 are supported to the respective guide shafts 104 and 104 so as to become freely slidable. The objective lens drive apparatus 108 includes a movable portion 108a and a fixed portion 108b and the movable portion 108a is supported to the fixed portion 108b through a suspension (not shown) so as to become freely movable. A nut member, not shown, provided on the moving base 107 is meshed with the lead screw 105 so that when the lead screw 105 is rotated by the feed motor, the nut member is transported in the direction corresponding to the rotation direction of the lead screw 105, thereby making it possible for the optical pickup apparatus 40 to move in the radius direction of the optical recording medium 10 placed on the disc table 103.

In the optical recording and reproducing apparatus 100 having this arrangement, when the disc table 103 is rotated as the spindle motor is rotated, the optical recording medium 10 placed on this disc table 103, that is, BD, DVD, CD or the like is rotated. At the same time, the optical pickup apparatus 40 is moved in the radius direction of the optical recording medium 10 by the above-mentioned mechanism, whereby the optical pickup apparatus 40 is made movable so as to oppose the whole of the recording surface of the optical recording medium 10. As a result, at the predetermined track position, the optical recording medium 10 can be recorded or reproduced by the optical pickup apparatus 40. At that time, the movable portion 108a of the objective lens drive apparatus 108 is moved relative to the fixed portion 108b, whereby focusing and tracking of an objective lens, which will be described later on, provided on the movable portion 108a may be adjusted.

The optical recording medium 10 for use with the optical recording and reproducing apparatus 100 and the optical pickup apparatus 40 according to the present invention might be a BD, a DVD, a CD and the like, for example. Laser lights available for those optical recording mediums 10 may have the following wavelengths: That is, when the optical recording medium 10 is the DVD, a wavelength of from 630 nm to 670 nm may be available; when the optical recording medium 10 is the CD, a wavelength of from 760 nm to 800 nm may be available; and when the optical recording medium 10 is the BD, a wavelength of from 400 nm to 415 nm may be available.

First, as a first embodiment of the present invention, an example of an optical pickup apparatus for recording and/or reproducing an optical recording medium conforming to the BD standards will be described with reference to a schematic arrangement diagram of FIG. 2. In this case, as shown in FIG. 2, the optical pickup apparatus 40 includes at least a light source 41, a beam splitter 45, a collimator lens 46, a mirror 44, a micro-mirror 48, an objective lens 3, a conversion lens 49 and a light-receiving element 50. These components other than the objective lens 3 are located on the moving base 107 which has been explained so far with reference to FIG. 1. The objective lens 3 is provided on the movable portion 108a of the objective lens drive apparatus 108 which has been described so far with reference to FIG. 1. In FIG. 2, elements and part identical to those of FIG. 1 are denoted by identical references numerals and therefore need not be described.

The light source 41 may emit laser light L1 having a wavelength ranging of from 400 nm to 415 nm corresponding to the optical recording medium conforming to the BD standards, for example, about 405 nm.

The beam splitter 45 has a function to pass or reflect laser light introduced thereto owing to a difference between polarization directions, whereby outward laser light is passed through the split surface and introduced into the collimator lens 46 and inward laser light is reflected on the split surface and introduced into the light-receiving element 50.

Laser light which was collimated by the collimator lens 46 is temporarily reflected by the mirror 44 and thereby its optical axis is converted in the direction shown by a solid line a with an angle θ between the direction extending along the recording track of the optical recording medium, that is, so-called tangential direction (shown by an arrow t in FIG. 2) and the radial direction (radius direction) shown by an arrow r of the optical recording medium.

This angle θ is selected as:
45°≦θ<90°

After that, laser light is converted in optical path approximately 90° by the reflection surface of the micro-mirror 48 in the direction substantially perpendicular to the sheet of drawing of FIG. 2, that is, in the direction substantially perpendicular to the recording surface of the optical recording medium and its polarization direction is converted by a quarter-wave plate (not shown). Also, the laser light is focused on the optical recording medium at its predetermined recording track position by the objective lens 3 through a suitable device such as a predetermined aberration correction element.

Then, the laser light reflected from the optical recording medium is introduced through the objective lens 3 and the like into the quarter-wave plate (not shown), in which it is again converted in polarization direction, reflected by the micro-mirror 48 and the mirror 44 and passed through the collimator lens 46, whereafter it is reflected on the split surface of a polarizing beam splitter 45 and introduced through a conversion lens 49 into the predetermined position of the light-receiving element 50 as shown by an arrow L2 and thereby a signal is detected by a predetermined detection mechanism (not shown).

In this optical pickup apparatus 40, a semiconductor laser is used as the light source 41. This laser light may be given a beam spot profile of a desired substantially ellipse shape by using a semiconductor laser in which the following equation is satisfied:
2≦θ⊥/θ//≦4
where θ⊥ is the spread angle of the far-field pattern (FFP) perpendicular to the active layer and θ// is the spread angle of the far-field pattern (FFP) parallel to the active layer.

Also, the light source 41 is located in such a manner that the spread direction of the far-field pattern parallel to this active layer, that is, the direction parallel to the active layer may be a plane perpendicular to the moving plane containing the moving direction of the moving base 107 on which a major optical system of the optical pickup apparatus 40 is located, that is, it may be substantially parallel to the direction extending along the recording surface of the optical recording medium.

At that time, the far-field pattern of laser light emitted from the light source 41 is laid in the θ⊥ direction, that is, the direction in which a substantially major axis direction of beam becomes perpendicular to the recording surface of the optical recording medium. A beam of light introduced into the micro-mirror 48 from the semiconductor laser light source is selected to be the direction from the extending direction of the recording track of the optical recording medium, that is the direction extending along the direction shown by the arrow t to the direction with the angle θ shown by the solid line a. When this angle θ is selected so as to satisfy 45°≦θ≦90°, the θ⊥ direction of the laser light can be located in the range of 45°≦θ<90° from the above-mentioned tangential direction on the optical recording medium.

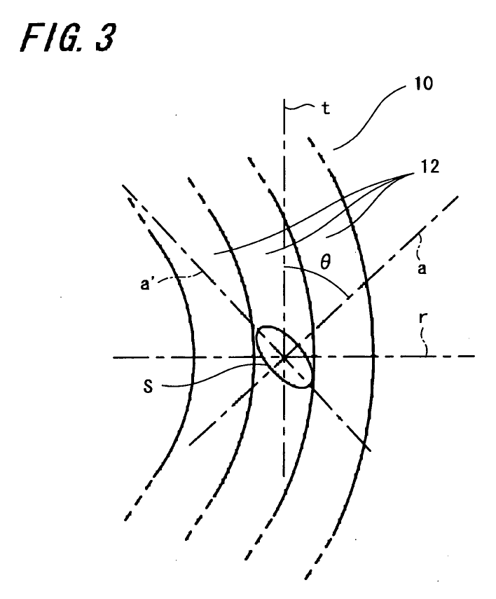

FIG. 3 is a schematic diagram showing an arrangement of a profile of a beam spot on the surface of the recording track of the optical recording medium.

A beam spot S of laser light is focused on a predetermined recording track 12 of the optical recording medium 10 in such a manner that its short axis direction (θ⊥ direction of semiconductor laser) shown by a dot-and-dash line a is inclined with an angle θ of 45°≦θ<90° from the tangential direction shown by a dot-and-dash line t which is the direction in which the recording tracks 12 are extended. In FIG. 3, a dot-and-dash line r denotes a radial direction (radius direction) and a dot-and-dash line a′ denotes a major axis direction of the beam spot S.

A beam spot intensity distribution is converted 90° when the beam is passed through the objective lens and in the intensity distribution of the beam spot on the signal recording surface of the optical recording medium, the major axis and the minor axis may be reversed.

According to the profile of the beam spot on the recording track, as compared with the case in which the minor axis direction of the beam spot on the signal recording surface is selected in a range of 45° from the tangential direction 0°, crosstalk and cross write relative to the adjacent track can be suppressed reliably and hence recording and reproducing characteristics can be maintained satisfactorily.

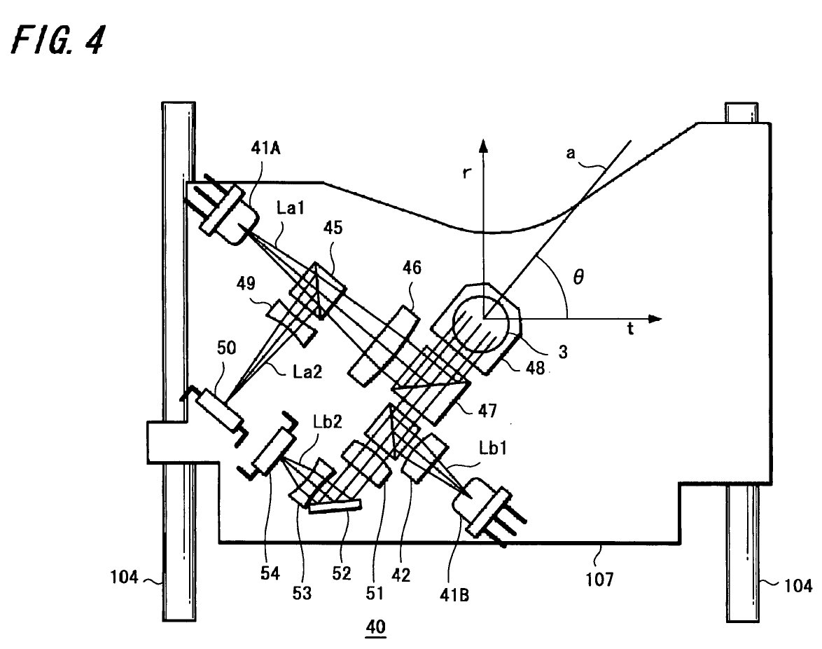

Another embodiment in which the present invention is applied to an optical pickup apparatus and an optical recording and reproducing apparatus which have compatibility with at least one of an optical recording medium conforming to the CD standards in which laser light having a wavelength ranging of from 760 nm to 800 nm is available and an optical recording medium conforming to the DVD standards in which laser light having a wavelength ranging of from 630 nm to 670 nm is available, in addition to the optical recording medium conforming to the BD standards being used as the optical recording medium will be described with reference to FIG. 4. In FIG. 4, elements and parts identical to those of FIG. 2 are denoted by identical reference numerals and therefore need not be described in detail.

This optical pickup apparatus 40 can be located in the optical recording and reproducing apparatus 100 having the arrangement which has been described so far with reference to FIG. 1.

As shown in FIG. 4, in this case, there are provided a first light source 41A which emits laser light having a wavelength of approximately 405 nm, for example, and a second light source 41B including two light-emitting elements capable of emitting laser light having a wavelength of approximately 660 nm and laser light having a wavelength of approximately 780 nm, for example. Laser light Lb1 emitted from the second light source 41B is collimated by the collimator lens 42, reflected on the split surface of the polarizing beam splitter 43 and introduced into an optical path synthesizing element 44. The optical path synthesizing element 44 has an arrangement to reflect laser light La1 emitted from the first light source 41A and which corresponds to the optical recording medium conforming to the BD standards with an angle of substantially 90° and to pass laser light Lb1 emitted from the second light source 41B and which corresponds to the optical recording medium conforming to the CD and DVD standards.

The laser lights of which optical paths are made nearly identical to each other by the optical path synthesizing element 47 are converted approximately 90° in optical path by the micro-mirror 48, traveled in the direction perpendicular to the optical recording medium and focused on the predetermined tracks on the optical recording medium 10 by an objective lens 48 through suitable devices such as a quarter-wave plate and an aberration correction element (not shown), similarly to the aforementioned embodiment shown in FIG. 2.

Then, laser light reflected from the optical recording medium 10 and which corresponds to the optical recording medium conforming to the CD and DVD standards is introduced through the objective lens 3 and the like into the quarter-wave plate (not shown), in which it is again converted in polarizing direction, reflected by the micro-mirror 48, passed through the optical path synthesizing element 47, passed through the split surface of the polarizing beam splitter 43, introduced into the predetermined position of a light-receiving element 54 through a collimator lens 51, a mirror 52 and a conversion lens 53 and a signal is detected by a predetermined detection mechanism, not shown.

As described above, when the optical pickup apparatus 40 and the optical recording and reproducing apparatus that are compatible with at least one of the optical recording mediums conforming to the CD standards and the DVD standards are constructed, it is desirable that the inclination angle θ of the minor axis direction a of the beam spot irradiated on the recording track of the optical recording medium should be selected from the tangential direction t so as to satisfy the following equation:
45°≦θ≦55°

As described above, when the optical pickup apparatus 40 and the optical recording and reproducing apparatus are made compatible with at least one of the optical recording medium conforming to the CD standards and the optical recording medium conforming to the DVD standards, the track pitch in the CD, DVD and the like is relatively large so that, even when the beam spot is inclined in the radial direction, crosstalk and cross write will not become serious problems. Particularly in the CD, DVD and the like, in order to suppress jitter between the recording marks of the tangential direction, it has been customary that the inclination of the minor axis of the beam spot from the tangential direction is selected to be less than 45°. Also in this embodiment, it is desirable that the inclination angle of the minor axis direction of the beam spot should be prevented from being increased considerably. Therefore, when the inclination angle θ of the minor axis direction of the beam spot is selected in a range of from 45°≦θ≦55° as mentioned above, it is possible to avoid recording and reproducing characteristics from being degraded.

As a result, it becomes possible to provide the optical pickup apparatus and the optical recording and reproducing apparatus which can retain satisfactory recording and reproducing characteristics relative to the optical recording medium conforming to the CD standard and/or DVD standards and the optical recording medium conforming to the BD standards.

As set forth above, according to the optical pickup apparatus, the optical recording and reproducing apparatus and the optical recording and reproducing method of the present invention, even when the semiconductor laser may be rotated without freedom or when the beam profile converter is not in use, it is possible to hold more stable and satisfactory recording and reproducing characteristics by properly selecting the inclination angle of the profile of the beam spot.

Further, when the optical pickup apparatus and the optical recording and reproducing apparatus which are compatible with the optical recording mediums such as the CD and the DVD are constructed, it becomes possible to hold satisfactory recording and reproducing characteristics relative to the respective optical recording mediums by further selecting the range of the inclination angle.

Furthermore, the present invention is not limited to the above-mentioned embodiments. In the arrangements of other optical recording and reproducing apparatus and optical pickup apparatus, layout of optical assemblies can be changed and various changed and additions of various optical elements, control mechanism and the like are also possible. Hence, it is needless to say that various modifications and alterations can be made without departing from the arrangement of the present invention.

As described above, according to the present invention, there are provided the optical pickup apparatus, the optical recording and reproducing apparatus and the optical recording and reproducing method in which when the light source includes the semiconductor and the direction parallel to the active layer is located in substantially parallel to the recording surface of the optical recording medium, light beam emitted from the semiconductor laser is reflected by the reflection surface in the direction substantially perpendicular to the recording surface of the optical recording medium and light having the wavelength of at least 400 nm to 415 nm is irradiated on the optical recording medium through the objective lens to record and/or reproduce the optical recording medium. When the angle θ formed between the direction of light beam incident on the reflection surface and the direction in which the recording tracks of the optical recording medium are extended is selected in a range of from 45°≦θ<90°, it is possible to obtain satisfactory recording and reproducing characteristics from the optical recording medium which may be recorded and/or reproduced with irradiation of the light having the wavelength of from 400 nm to 415 nm.

Also, when the above-described angle θ is further selected in a range of from 45≦θ≦55°, it is possible to obtain satisfactory recording and reproducing characteristics from optical recording mediums which may be recorded and/or reproduced with irradiation of light having other wavelength regions.

Furthermore, in the above-mentioned optical pickup apparatus, when the spread angle of the far-field pattern perpendicular to the active layer of light emitted from the semiconductor layer is assumed to be θ⊥ and the spread angle of the far-field pattern parallel to the active layer is assumed to be θ//, 2≦θ⊥/θ//≦4 is satisfied and hence the corresponding direction can be selected in the above-mentioned direction so that it is possible to obtain satisfactory recording and reproducing characteristics.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup apparatus comprising:
a semiconductor laser for emitting laser light with a wavelength of at least from 400 nm to 415 nm and of which plane parallel to an active layer is located substantially in parallel to the recording surface of an optical recording medium; and
a reflection surface for reflecting laser light emitted from said semiconductor laser in the direction substantially perpendicular to the recording surface of said optical recording medium, said laser light being irradiated on said optical recording medium through an objective lens to record and/or reproduce said optical recording medium, wherein an angle θ formed between the direction of rays of light introduced into said reflection surface from said semiconductor laser and the direction in which recording tracks of said optical recording medium are extended is selected so as to satisfy:
45°≦θ<90°

2. The optical pickup apparatus according to claim 1, wherein said angle θ is selected so as to satisfy:
45°≦θ≦55°

3. The optical pickup apparatus according to claim 1, wherein when θ⊥ assumes a spread angle of a far-field pattern, perpendicular to the active layer, of laser light emitted from said semiconductor laser and θ// assumes a spread angle of a far-field pattern parallel to said active layer, the following equation is given as:
2≦↓⊥/θ//≦4

4. The optical pickup apparatus according to claim 1, further comprising a semiconductor laser for emitting laser light with a wavelength of at least 630 nm to 670 nm.

5. The optical pickup apparatus according to claim 1, wherein laser light emitted from said second semiconductor laser is reflected by said reflection surface in the direction substantially perpendicular to the recording surface of said optical recording medium, said laser light being irradiated on said optical recording medium through said objective lens.

6. An optical recording and reproducing apparatus including an optical pickup apparatus comprising:
a semiconductor laser for emitting laser light with a wavelength of at least from 400 nm to 415 nm and of which plane parallel to an active layer is located substantially in parallel to the recording surface of an optical recording medium; and
a reflection surface for reflecting laser light emitted from said semiconductor laser in the direction substantially perpendicular to the recording surface of said optical recording medium, said laser light being irradiated on said optical recording medium through an objective lens to record and/or reproduce said optical recording medium, wherein an angle θ formed between the direction of rays of light introduced into said reflection surface from said semiconductor laser and the direction in which recording tracks of said optical recording medium are extended is selected so as to satisfy:
45°≦θ<90°

7. The optical recording and reproducing apparatus according to claim 6, wherein said angle θ is selected so as to satisfy:
45°≦θ≦55°

8. The optical recording and reproducing apparatus according to claim 6, wherein when θ⊥ assumes a spread angle of a far-field pattern, perpendicular to the active layer, of laser light emitted from said semiconductor laser and θ// assumes a spread angle of a far-field pattern parallel to said active layer, the following equation is given as:
2≦θ⊥/θ//≦4

9. The optical recording and reproducing apparatus according to claim 6, further comprising a semiconductor laser for emitting laser light with a wavelength of at least 630 nm to 670 nm.

10. An optical recording and reproducing method, in which a semiconductor laser is provided as a light source, the direction parallel to an active layer of said semiconductor laser is located in substantially parallel to the recording surface of an optical recording medium, laser light emitted from said semiconductor laser is reflected by a reflection surface in the direction substantially perpendicular to the recording surface of said optical recording medium and light having a wavelength of at least 400 nm to 415 nm is irradiated on said optical recording medium through an objective lens to record and/or reproduce said optical recording medium, wherein an angle θ formed between the direction of rays of light introduced into said reflection surface from said semiconductor laser and the direction in which recording tracks of said optical recording medium are extended is selected so as to satisfy:
45°≦θ<90°

11. The optical recording and reproducing method according to claim 10, wherein said angle θ is selected so as to satisfy:
45°≦θ≦55°
